(19) United States
(12) Patent Application Publication
(10) Pub. No.: US 2026/0225228 A1
(43) Pub. Date: Aug. 6, 2026

(54) ROBOT BRAZING SYSTEM

(71) Applicant: Lincoln Global, Inc., Cleveland, OH (US)

(72) Inventors: Mark J. Wilson, Killen, AL (US); Leandro Calcada, Liberty Township, OH (US); Edwin B. Lawson, Florence, AL (US)

(21) Appl. No.: 19/530,500

(22) Filed: Feb. 5, 2026

Related U.S. Application Data
(60) Provisional application No. 63/754,684, filed on Feb. 6, 2025.

(51) Int. Cl. B25J 9/00; B23K 37/04; B25J 11/00

(52) U.S. Cl. CPC B25J 9/0096; B23K 37/0435; B23K 37/0452; B25J 11/005

(57) ABSTRACT

An automated brazing system includes a rotatable platform, a first fixture frame attached to the rotatable platform and configured to hold a first header assembly, and a second fixture frame attached to the rotatable platform and configured to hold a second header assembly. A first clamp is attached to the rotatable platform. The first clamp is configured to hold a first header body. A second clamp is attached to the rotatable platform. The second clamp is configured to hold a second header body. The automated brazing system further includes a robot arm. A brazing torch is attached to the robot arm. The robot arm is configured to automatically perform brazing operations on said header assemblies and said header bodies when they are located at the brazing station via rotation of the rotatable platform.

### CROSS-REFERENCE TO RELATED APPLICATIONS

The present application claims priority to U.S. Provisional Patent Application Serial Number 63/754,684 filed on February 6, 2025, the disclosure of which is incorporated herein by reference.

### BACKGROUND OF THE INVENTION

### Field of the Invention

The present invention relates to an automated brazing system, and in particular to an automated brazing system that employs a robot for making brazed connections to metal tubes.

### Description of Related Art

Brazing is used to join metal members together with a brazing filler, i.e., a metal or alloy having a lower melting point than the metals to be joined. Brazing typically involves the use of a torch provided with two gasses. One of the gases will include a flammable fuel gas such as LP gas, natural gas, acetylene gas, methane, propane, butane, hydrogen and mixtures and combinations thereof, while the other gas will include a combustion-assisting gas such as oxygen or pressurized air. A mass flow controller having flow control valves can control the flow of the fuel gas and combustion-assisting gas to the torch during a brazing operation.

When making brazed connections, care must be taken to avoid overheating and damaging the components to be joined. This is particularly true when brazing aluminum components because the melting point of the brazing alloy or filler metal can be close to the melting point of the aluminum components. It is not uncommon for an operator performing manual brazing, in particular an inexperienced operator, to accidentally overheat the braze joint and damage the components. An automated brazing system can eliminate such operator error.

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is an automated brazing system. The automated brazing system includes a rotatable platform, a first fixture frame attached to the rotatable platform and configured to hold a first header assembly, and a second fixture frame attached to the rotatable platform and configured to hold a second header assembly. A first clamp is attached to the rotatable platform. The first clamp is configured to hold a first header body. A second clamp is attached to the rotatable platform. The second clamp is configured to hold a second header body. The automated brazing system further includes a robot arm. A brazing torch is attached to the robot arm. The robot arm is configured to automatically perform brazing operations on said header assemblies and said header bodies when they are located at the brazing station via rotation of the rotatable platform.

In accordance with another aspect of the present invention, provided is an automated brazing system. The automated brazing system includes a rotatable platform, a first fixture frame attached to the rotatable platform and configured to hold a first header assembly, a second fixture frame attached to the rotatable platform and configured to hold a second header assembly, and a third fixture frame attached to the rotatable platform and configured to hold a third header assembly. A first clamp is attached to the rotatable platform and is located between the first fixture frame and the second fixture frame. The first clamp is configured to hold a first header body. A second clamp is attached to the rotatable platform and is located between the second fixture frame and the third fixture frame. The second clamp is configured to hold a second header body. A third clamp is attached to the rotatable platform and is located between the third fixture frame and the first fixture frame. The third clamp is configured to hold a third header body. The automated brazing system further includes a robot arm. A brazing torch is attached to the robot arm. The robot arm is configured to automatically perform a first brazing operation on the first header body when rotated to the brazing station by the rotatable platform, and also a second brazing operation on the first header body when subsequently rotated back to the brazing station by the rotatable platform after passing through a cooling station and a loading station.

In accordance with another aspect of the present invention, provided is an automated brazing system. The automated brazing system includes a rotatable platform, a first fixture frame attached to the rotatable platform and configured to hold a first header assembly, a second fixture frame attached to the rotatable platform and configured to hold a second header assembly, and a third fixture frame attached to the rotatable platform and configured to hold a third header assembly. A first clamp is attached to the rotatable platform and is located between the first fixture frame and the second fixture frame. The first clamp is configured to hold a first header body. A second clamp is attached to the rotatable platform and is located between the second fixture frame and the third fixture frame. The second clamp is configured to hold a second header body. A third clamp is attached to the rotatable platform and is located between the third fixture frame and the first fixture frame. The third clamp is configured to hold a third header body. A robot arm is located at a brazing station of the automated brazing system. A brazing torch is attached to the robot arm. The robot arm is configured to automatically perform brazing operations on said header assemblies and said header bodies after they are rotated to the brazing station by the rotatable platform.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 shows an automated brazing system;

FIG. 2A shows a clamp in the closed position;

FIG. 2B shows the clamp in the open position;

FIG. 3 shows a first brazing operation;

FIG. 4 shows a second brazing operation;

FIG. 5 shows a third brazing operation;

FIG. 6 is a top plan view of the automated brazing system;

FIG. 7 is a control system block diagram; and

FIG. 8 is a block diagram of an example controller.

### DETAILED DESCRIPTION OF THE INVENTION

The present invention relates to an automated brazing system, and in particular to an automated brazing system that employs a robot for making brazed connections to metal tubes such as aluminum or copper tubes. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

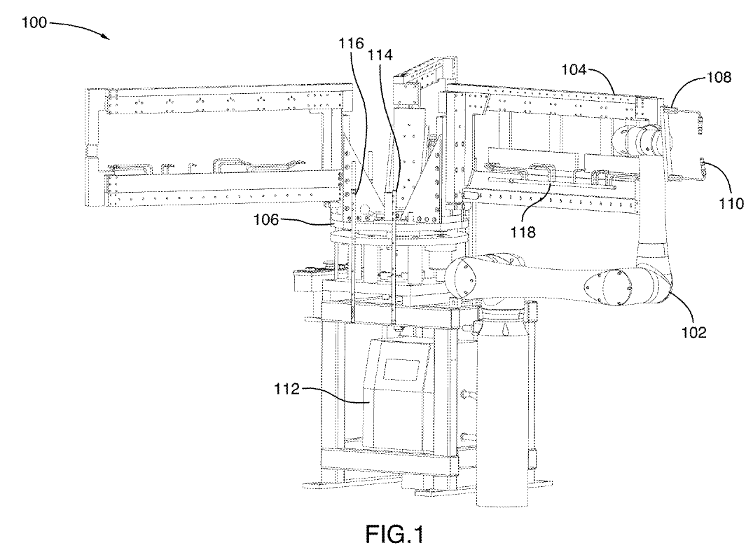

FIG. 1 shows an automated brazing system 100. The system 100 includes a brazing station at which brazing operations occur and are performed by a robot arm 102 (hereinafter “robot”). In certain embodiments, the robot 102 is located at the brazing station of the automated brazing system 100. However, the robot 102 could be located near or adjacent to the brazing station so long as the robot’s end effector can reach the parts or workpieces to be brazed when said parts are located at the brazing station.

The robot 102 can be a 6-axis robot arm. In certain embodiments, the robot 102 can be a collaborative robot (cobot) that can be operated in close proximity to a user or operator, such as within a shared area. Cobots are designed to work safely alongside humans in shared workspaces without the need for extensive safety barriers. Unlike traditional industrial robots that operate in isolated environments, cobots are equipped with sensors, force-limiting technology, and intuitive programming interfaces to ensure human safety and ease of use and help bridge the gap between automation and human labor by enhancing productivity while maintaining a collaborative approach.

As will be discussed in detail below, the robot 102 can perform several different brazing operations on various parts located at the brazing station.

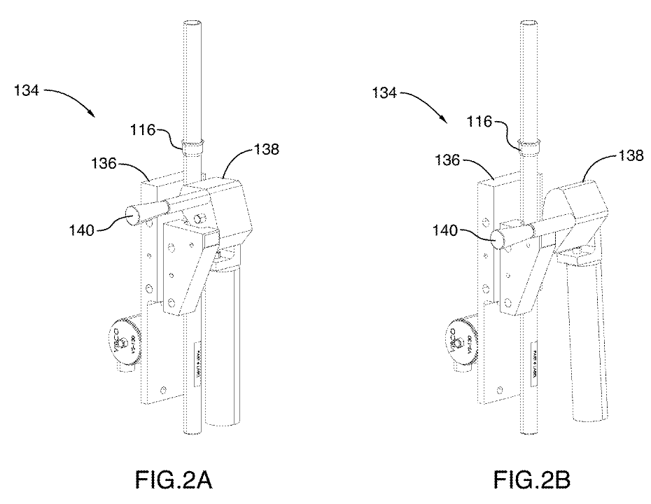

FIG. 1 shows a view of the automated brazing system 100 looking toward the brazing station. However, the system 100 also includes two additional stations, which are a cooling station and a loading station. The brazing station, the cooling station, and the loading station can be spaced approximately 120 degrees apart from each other. The brazing station, the cooling station and the loading station each have the same fixturing for holding parts. The fixturing includes a fixture frame 104, and additional clamps not shown in FIG. 1 but shown in FIGS. 2A and 2B, to support parts to be brazed or parts that have already been brazed. Thus, the fixture frame 104 shown in FIG. 1, and the clamps shown in FIGS. 2A and 2B, would also be present at the cooling station and the loading station. The brazing system 100 includes a rotatable platform 106 to which the fixture frame 104 and clamps are attached. The rotatable platform 106 allows parts held by the fixturing to be moved from station to station, such as from the brazing station to the cooling station, from the cooling station to the loading station, and from the loading station to the brazing station. However, the purpose of each station is different. While brazing is occurring at the brazing station, other parts that have already been brazed are cooling at the cooling station, while simultaneously cooled parts are unloaded or repositioned and other parts loaded for brazing by an operator at the loading station.

The end effector 108 or end of arm tool on the robot 102 includes one or more brazing torches 110 attached to the robot arm. In the embodiment shown in FIG. 1, the end effector 108 has two brazing torches 110. However, the end effector could have a single brazing torch or more than two brazing torches in other embodiments.

The brazing system 100 can include a mass flow controller (MFC) 112 that controls the flow of fuel gas and combustion-assisting gas to the torches 110. An example MFC 112 is the PERFECT FLAME mass flow controller available from The Harris Products Group of Mason, Ohio. The structure and operation of MFCs for brazing applications is well known and need not be discussed in detail herein. Such MFCs allow an operator or other controller, such as a programmable logic controller (PLC), to set the ratio of fuel gas to combustion-assisting (e.g., oxygen). During a brazing operation, the MFC 112 controls gas flow to achieve a desired heating profile (e.g., heat amount or BTU over time) at the brazed joint. The MFC 112 can automatically adjust the gas flows to the torches to achieve the desired heating profile while maintaining a set gas ratio. For example, during brazing the MFC 112 can automatically reduce the gas flows to reduce the flame temperature so as not to overheat the brazed joint and damage the connected tubes while also heating the brazed joint to a desired final temperature. The MFC 112, or a PLC in communication with the MFC, can store multiple heating profiles, which can be selected for a particular brazing operation. The MFC 112 can also have an idle mode that produces a very low flame output but maintains the set gas ratio.

The robot 102 is programmed to automatically perform various different brazing operations on parts held by the fixtures and clamps of the brazing system 100. Each brazing operation can have its own heating profile that is implemented by the MFC 112. In the embodiment shown in FIG. 1, three different parts are to be brazed. However, the brazing system 100 could be configured for brazing fewer or more than three different parts. The parts to be brazed in FIG. 1 include a header body 114 (also called a manifold body), a header body and copper tube assembly 116, and a header body/copper tube assembly and header legs 118. The header legs are also called feeder tubes.

The brazing station, cooling station, and loading station can include identical fixturing attached to the rotatable platform 106. The fixturing holds the parts 114, 116, 118 to be brazed. The fixture frame 104 holds a header assembly (e.g., the header body/copper tube assembly and header legs 118). Once brazed, the header body/copper tube assembly and header legs 118 becomes a completed header assembly. Example fixturing for holding the header body 114 and the header body and copper tube assembly 116 is shown in detail in FIGS. 2A and 2B. This fixturing is a clamp 134 that is attached to the rotatable platform. Any suitable clamp could be used to hold the header body 114 (FIG. 1) or header body and copper tube assembly 116 vertically for brazing. However, in the example embodiment shown in FIGS. 2A and 2B, the clamp 134 includes a backing plate 136 having a notch for receiving the header body, and a hinged weight 138 that holds the header body in the notch. The clamp 134 has an over-center design that holds the clamp open or closed by gravity according to the position of the hinged weight 138. The hinged weight 138 can include a handle 140 that allows an operator to rotate the weight between the closed position shown in FIG. 2A and the open position shown in FIG. 2B. In the example embodiment shown in the figures, each station has one fixture frame 104 and two clamps 134 for holding parts, and the two clamps are located between successive fixture frames. However, in other embodiments, the stations can have additional or fewer fixtures depending on the number of parts to be brazed.

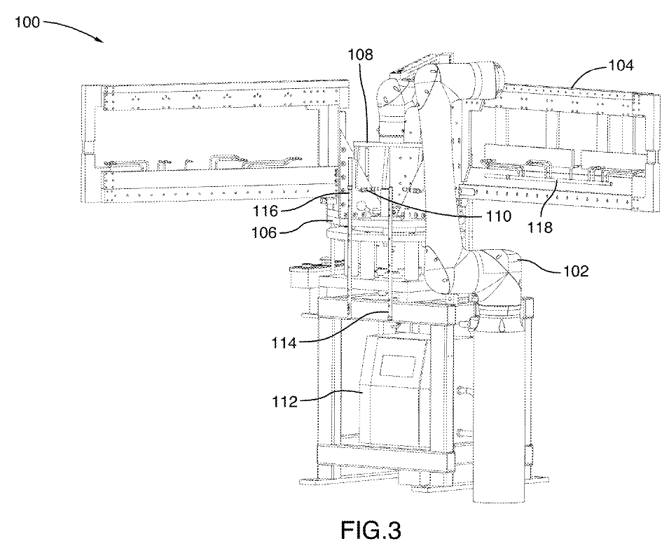

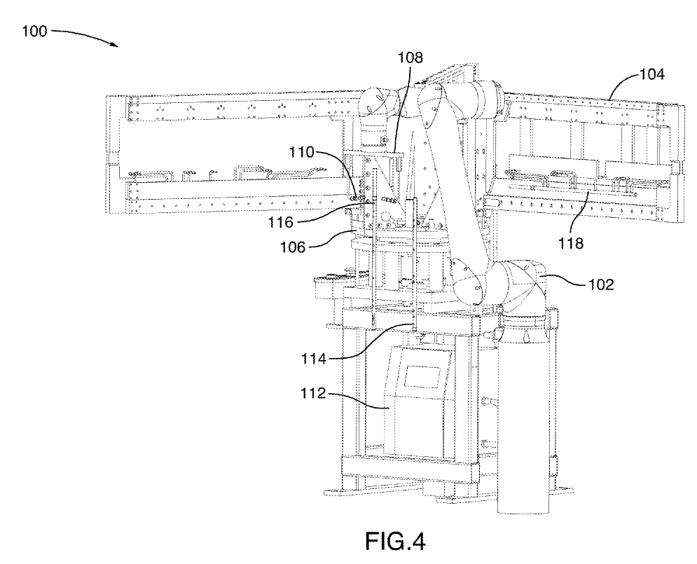

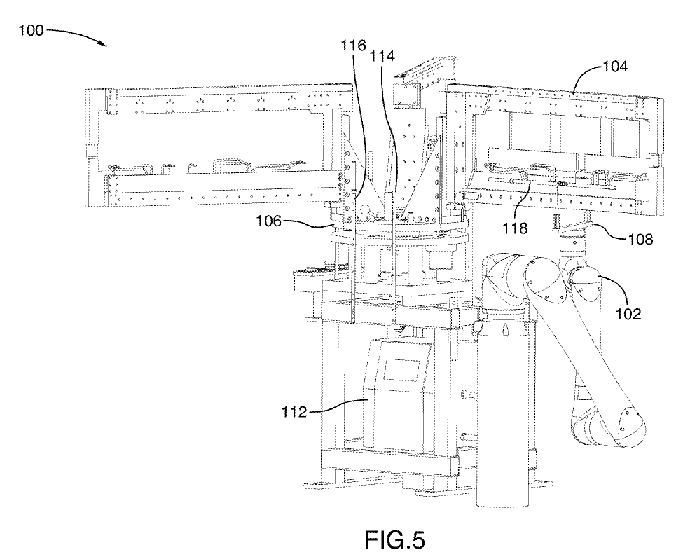

FIGS. 3-5 show the robot 102, end effector 108, and brazing torches 110 positioned to perform different brazing operations on the header body 114 (FIG. 3), the header body and copper tube assembly 116 (FIG. 4), and the header body/copper tube assembly and header legs 118 (FIG. 5). The brazing operations are performed in sequence on the different parts 114, 116, 118 in any desired order.

In FIG. 3, the robot 102 is positioned to perform brazing and thermal degreasing on the header body 114. For example, a brazing ring can be placed on the upper end of the header body 114 and melted by the torches 110 to seal the upper end of the header body 114. The robot 102 can also thermally degrease the header body 114 by moving the torches 110 upward and downward along the length of the header body and rotating the torches if desired, to burn off any oil on the header body before subsequent further brazing operations.

In FIG. 4, the robot 102 is positioned to perform brazing on the header body and copper tube assembly 116. The header body portion of the header body and copper tube assembly 116 is identical to header body 114, but its orientation is reversed so that a flared end is pointed upward to receive the copper tube and a brazing ring. The robot 102 brazes the copper tube to the header body along the flared end via up and down and rotational movements of the torches 110.

In FIG. 5, the robot 102 is positioned to perform brazing on the header body/copper tube assembly and header legs 118. The header body/copper tube assembly is oriented generally horizontally in the fixture frame 104, and a plurality of header legs are brazed to the header body by the torches 110 to make a completed header assembly.

After the brazing operations discussed above are completed, the robot 102 can return to a standby position shown in FIG. 1 and the torches 110 placed in a low flame, idle mode. In the standby position, the robot 102 is clear of the fixture frame 104, which allows the platform 106 to be rotated 120 degrees to move the brazed, hot parts 114, 116, 118 to the cooling station. Rotating the platform 106 will simultaneously move recently loaded and unbrazed parts from the loading station to the brazing station, and will also deliver cooled brazed parts from the cooling station to the loading station for removal or repositioning on the fixturing. The platform 106 can be rotated manually by the operator or automatically if desired.

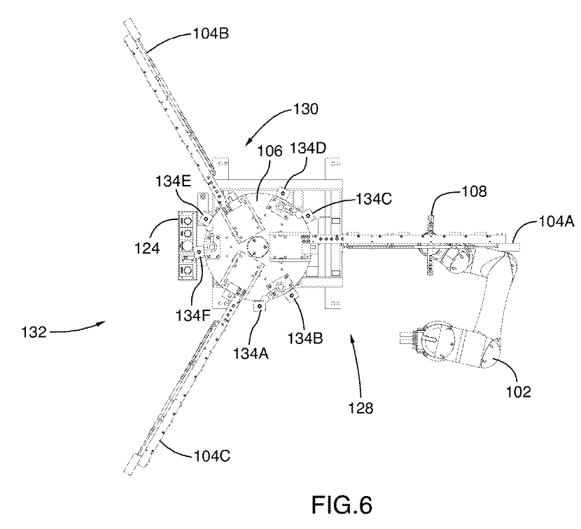

Turning to the system top plan view of FIG. 6, the brazing station 128, the cooling station 130, and the loading station 132 are shown. Each station 128, 130, 132 includes an identical fixture frame 104A, 104B, 104C, respectively, and clamps 134A-F, which are spaced approximately 120 degrees apart for holding parts. The brazing system can include an operator panel 124 that is located at or adjacent to the loading station 132 to allow the operator to start and stop or otherwise control the brazing operations.

The robot 102 is configured to automatically perform brazing operations on the header assemblies and header bodies after they are rotated to and located at the brazing station 128 by the rotatable platform 106. With reference to FIG. 1 and FIGS. 3-6, at the loading station 132, the operator removes a completed header assembly comprising the header body/copper tube assembly and header legs 118 from the fixture frame 104C and replaces it with the brazed header body and copper tube assembly 116 now located at the loading station. That is, the operator removes the brazed header body and copper tube assembly 116 from its clamp and places it in the now empty fixture frame 104C. The operator then positions the header legs on the brazed header body and copper tube assembly 116 and adds brazing material to the joints to be brazed. The operator also removes the degreased header body 114 from its clamp at the loading station 132, flips it over, and replaces the removed brazed header body and copper tube assembly 116 (now in the fixture frame 104C) with the degreased header body 114. The operator adds a brazing ring and the copper tube to the flared, upwardly pointing end of the degreased header body 114. The operator also replaces the degreased header body 114 that has just been removed with a new header body (e.g., retrieved from a storage area – not shown) for subsequent sealing and thermal degreasing. Thus, it is to be appreciated that a header body 114 can make three passes through the brazing station 128, and receive three different brazing operations, to create a completed header assembly: Pass 1 – sealing and thermal degreasing; Pass 2 – connection of the copper tube; and Pass 3 – connection of the header legs. Pass 2 and its brazing operations occur subsequent to Pass 1 when the header body 114 is first rotated back to the brazing station. Pass 3 and its brazing operations occur subsequent to Pass 2 when the header body 114 is rotated to the brazing station for a third time. In certain embodiments, the header bodies 114 passes through the brazing station 128 at least three times to form respective complete header assemblies. It is to be appreciated that, depending on the complexity of the completed header assembly, the header body 114 could pass through the brazing station 128, cooling station 130, and loading station 132 fewer or more than three times, and receive a corresponding number of different brazing operations.

In known prior art automated brazing systems, such as the system disclosed in U.S. Patent No. 10,265,791 incorporated herein by reference, brazing steps similar to those discussed above are performed at entirely separate brazing stations. For example, different types of parts are brazed at the separate brazing stations. Such systems require additional floor space to accommodate the separate brazing stations, and require additional operators, as compared to the system 100 discussed herein. The robot 102 of the present brazing system 100 allows multiple, substantially different brazing operations to occur at a single station under the control of a single operator.

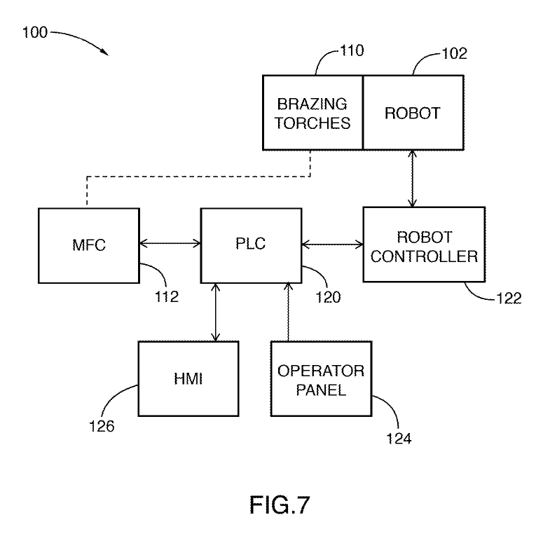

FIG. 7 shows an example control system block diagram for the brazing system 100. The control system can include a PLC 120 as a main controller for coordinating the operations of the robot controller 122 and the MFC 112. The PLC 120 can store robot positioning data and heating profiles for various parts to be brazed. The robot positioning data is communicated to the robot controller 122, and heating profiles are communicated to the MFC 112 prior to a brazing operation. The MFC 112 controls the flow of fuel gas and combustion-assisting gas to the brazing torches 110 according to the heating profile received from the PLC 120. The robot controller 122 controls the movements of the robot 102 during brazing according to the positioning data received from the PLC 120. The brazing system 100 can include the operator panel 124, which is located at or adjacent to the loading station. The operator panel 124 can include indicator lights and pushbuttons and/or other user interface elements to allow the operator to start and stop the brazing operations from the loading station. The brazing system 100 can also include a human machine interface (HMI) 126 that communicates bidirectionally with the PLC 120. The HMI 126 allows the operator to select particular parts to be brazed or adjust operating parameters, and the PLC sends the appropriate heating profiles to the MFC 112 and positioning data to the robot controller 122 in accordance with the selected parts and/or operating parameters. The HMI 126 can be located at the loading station or outside of the loading station, but preferably near the brazing system 100.

In certain embodiments, the automated brazing system can include additional robots to perform various tasks, such as part removal and replacement or wire feeding to the brazing point. For example, a second robot could feed brazing wire such as aluminum wire, to the brazing point.

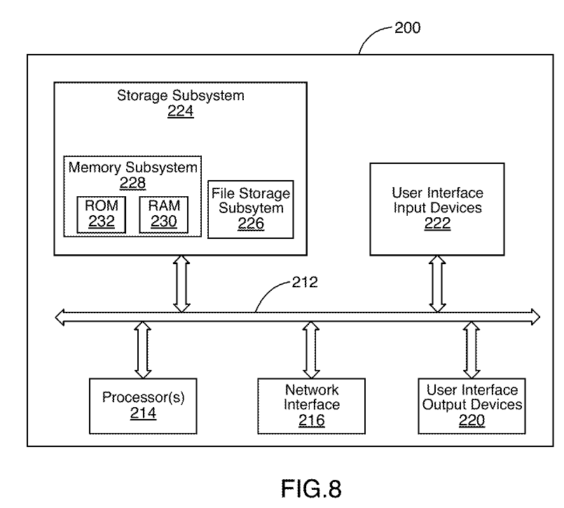

FIG. 8 illustrates an embodiment of an example controller 200 of the brazing system (e.g., a controller of the PLC, MFC and/or the robot controller). The controller 200 includes at least one processor 214 which communicates with a number of peripheral devices via bus subsystem 212. These peripheral devices may include a storage subsystem 224, including, for example, a memory subsystem 228 and a file storage subsystem 226, user interface input devices 222, user interface output devices 220, and a network interface subsystem 216. The input and output devices allow user interaction with the controller 200. Network interface subsystem 216 provides an interface to outside networks and is coupled to corresponding interface devices in other computer systems.

User interface input devices 222 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term "input device" is intended to include all possible types of devices and ways to input information into the controller 200 or onto a communication network.

User interface output devices 220 may include a display subsystem, a printer, a fax machine, or non-visual displays such as audio output devices. The display subsystem may include a cathode ray tube (CRT), a flat-panel device such as a liquid crystal display (LCD) or LED display, a projection device, or some other mechanism for creating a visible image. The display subsystem may also provide non-visual display such as via audio output devices. In general, use of the term “output device” is intended to include all possible types of devices and ways to output information from the controller 200 to the user or to another machine or computer system.

Storage subsystem 224 provides a non-transitory, computer-readable storage medium that stores programming and data constructs that provide the functionality of some or all of the software operations described herein. For example, the storage subsystem 224 may include programmed robot movements, brazing heating profiles, etc. These software operations are generally executed by processor 214 alone or in combination with other processors. Memory 228 used in the storage subsystem can include a number of memories including a main random access memory (RAM) 230 for storage of instructions and data during program execution and a read only memory (ROM) 232 in which fixed instructions are stored. A file storage subsystem 226 can provide persistent storage for program and data files, and may include solid state memory, a hard disk drive, a floppy disk drive along with associated removable media, a CD-ROM drive, an optical drive, flash memory, or removable media cartridges. The modules implementing the functionality of certain embodiments may be stored by file storage subsystem 226 in the storage subsystem 224, or in other machines accessible by the processor(s) 214.

Bus subsystem 212 provides a mechanism for letting the various components and subsystems of the controller 200 communicate with each other as intended. Although bus subsystem 212 is shown schematically as a single bus, alternative embodiments of the bus subsystem may use multiple buses.

The controller 200 can be of varying types including a PLC, workstation, server, computing cluster, blade server, server farm, or any other data processing system or computing device. Due to the ever-changing nature of computing devices and networks, the description of the controller 200 depicted in FIG. 8 is intended only as a specific example for purposes of illustrating some embodiments. Many other configurations of the controller 200 are possible having more or fewer components than the controller depicted in FIG. 8.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An automated brazing system, comprising:
a rotatable platform;
a first fixture frame attached to the rotatable platform and configured to hold a first header assembly;
a second fixture frame attached to the rotatable platform and configured to hold a second header assembly;
a first clamp attached to the rotatable platform, wherein the first clamp is configured to hold a first header body;
a second clamp attached to the rotatable platform, wherein the second clamp is configured to hold a second header body;
a robot arm; and
a brazing torch attached to the robot arm,
wherein the robot arm is configured to automatically perform brazing operations on said header assemblies and said header bodies when they are located at the brazing station via rotation of the rotatable platform.

2. The automated brazing system of claim 1, wherein the first fixture frame and the second fixture frame are spaced approximately 120 degrees apart from each other.

3. The automated brazing system of claim 1, wherein the automated brazing system further includes a cooling station and a loading station.

4. The automated brazing system of claim 3, wherein the robot arm is configured to automatically perform a first brazing operation on the first header body when rotated to the brazing station by the rotatable platform, and also a second brazing operation on the first header body when subsequently rotated back to the brazing station by the rotatable platform after passing through the cooling station and the loading station.

5. The automated brazing system of claim 1, wherein the first clamp and the second clamp are located between the first fixture frame and the second fixture frame.

6. The automated brazing system of claim 1, wherein the first clamp and the second clamp each include a hinged weight and a handle attached to the hinged weight.

7. The automated brazing system of claim 1, wherein the robot arm is configured to perform thermal degreasing operations on the header bodies.

8. The automated brazing system of claim 1, wherein said header bodies pass through the brazing station at least three times to form respective complete header assemblies.

9. An automated brazing system, comprising:
a rotatable platform;
a first fixture frame attached to the rotatable platform and configured to hold a first header assembly;
a second fixture frame attached to the rotatable platform and configured to hold a second header assembly;
a third fixture frame attached to the rotatable platform and configured to hold a third header assembly;
a first clamp attached to the rotatable platform and located between the first fixture frame and the second fixture frame, wherein the first clamp is configured to hold a first header body;
a second clamp attached to the rotatable platform and located between the second fixture frame and the third fixture frame, wherein the second clamp is configured to hold a second header body;
a third clamp attached to the rotatable platform and located between the third fixture frame and the first fixture frame, wherein the third clamp is configured to hold a third header body;
a robot arm; and
a brazing torch attached to the robot arm,
wherein the robot arm is configured to automatically perform a first brazing operation on the first header body when rotated to the brazing station by the rotatable platform, and also a second brazing operation on the first header body when subsequently rotated back to the brazing station by the rotatable platform after passing through a cooling station and a loading station.

10. The automated brazing system of claim 9, wherein the first fixture frame, the second fixture frame, and the third fixture frame are spaced approximately 120 degrees apart from each other.

11. The automated brazing system of claim 9, wherein the brazing station, the cooling station, and the loading station are spaced approximately 120 degrees apart from each other.

12. The automated brazing system of claim 9, wherein the first clamp, the second clamp, and the third clamp each include a hinged weight and a handle attached to the hinged weight.

13. The automated brazing system of claim 9, wherein the robot arm is configured to perform thermal degreasing operations on the header bodies.

14. The automated brazing system of claim 9, wherein said header bodies pass through the brazing station at least three times to form respective complete header assemblies.

15. An automated brazing system, comprising:
a rotatable platform;
a first fixture frame attached to the rotatable platform and configured to hold a first header assembly;
a second fixture frame attached to the rotatable platform and configured to hold a second header assembly;
a third fixture frame attached to the rotatable platform and configured to hold a third header assembly;
a first clamp attached to the rotatable platform and located between the first fixture frame and the second fixture frame, wherein the first clamp is configured to hold a first header body;
a second clamp attached to the rotatable platform and located between the second fixture frame and the third fixture frame, wherein the second clamp is configured to hold a second header body;
a third clamp attached to the rotatable platform and located between the third fixture frame and the first fixture frame, wherein the third clamp is configured to hold a third header body;
a robot arm located at a brazing station of the automated brazing system; and
a brazing torch attached to the robot arm,
wherein the robot arm is configured to automatically perform brazing operations on said header assemblies and said header bodies after they are rotated to the brazing station by the rotatable platform.

16. The automated brazing system of claim 15, wherein the first fixture frame, the second fixture frame, and the third fixture frame are spaced approximately 120 degrees apart from each other.

17. The automated brazing system of claim 15, wherein the automated brazing system further includes a cooling station and a loading station, and wherein the brazing station, the cooling station, and the loading station are spaced approximately 120 degrees apart from each other.

18. The automated brazing system of claim 17, wherein the robot arm is configured to automatically perform respective first brazing operations on each of the header bodies when they are rotated to the brazing station by the rotatable platform, and also respective second brazing operations on each of the header bodies when they are subsequently rotated back to the brazing station by the rotatable platform after passing through the cooling station and the loading station.

19. The automated brazing system of claim 15, wherein the robot arm is configured to perform thermal degreasing operations on the header bodies.

20. The automated brazing system of claim 15, wherein said header bodies pass through the brazing station at least three times to form respective complete header assemblies.
